(19) United States
(12) Patent Application Publication
(10) Pub. No.: US 2008/0140467 A1
(43) Pub. Date: Jun. 12, 2008

(54) Method and system for developing and managing interpersonal relationships

(76) Inventor: William M. Hull, Overland Park, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/217,512

(22) Filed: Sep. 1, 2005

(51) Int. Cl. G06Q 99/00; G06Q 10/00

(52) U.S. Cl. 705/7; 705/1

(57) ABSTRACT

The present invention is directed to a method that combines self-perception testing and personnel distribution to more effectively manage employees internally and clients externally. In particular, the present invention provides a method for developing and managing personnel that include providing a user interface, logging on to a central controller from the user interface, establishing a communication link with the central controller, inputting answer data in response to queries transmitted by the central controller, linking the answer data to behavioral trait data, determining a communication style result, and transmitting the result to the user interface.

### BACKGROUND OF THE INVENTION

The present invention is directed to a method that combines self-perception testing and personnel distribution to more effectively manage employees internally and clients externally.

Stronger competition, budget constraints, and high employee turnover are all problems facing today's business owners. However, working harder or longer hours does not solve these issues because many employees have poor communication and interpersonal skills leading to interpersonal difficulties in the ranks. These behaviors result in duplication of efforts, frustration, and lower productivity among employees. In an effort to overcome these personnel issues, many companies engage in traditional psychological or self-perception testing for its employees, especially management-level employees, in an effort to improve the performance of the employees overall. Traditional self-perception tests have each employee determine which of the four major communication styles that particular person employs. The four communication styles are given various names by different tests such as intuitor, thinker, senser and feeler or bridge-builder, thinker, bottom-liner, and energizer. Regardless of the name associated with a particular communication style, most self-perception tests categorize communication styles uniformly by traits. Employees are then instructed in the types of communication styles in order to sharpen their ability to recognize and understand the communication styles of others. Theoretically, this enables those employees to more effectively overcome communication problems in dealing with higher-ups, subordinates, and peers. Employees also learn how personality differences and different agendas can be more easily accommodated when they examine their own communication style in relation to others. However, for example, in the real world workplace, an employee with a senser personality (someone who is easily irritated by inefficiency or indecision) will still continue to have difficulty communicating with someone having a thinker personality (deliberate, overly-cautious decision-making). It is desirable, therefore, to provide a means by which employees can use their personal communication styles more effectively with each other and with clients.

### BRIEF SUMMARY OF THE INVENTION

The present invention provides a method for developing and managing personnel that include providing a user interface, logging on to a central controller from the user interface, establishing a communication link with the central controller, inputting answer data in response to queries transmitted by the central controller, linking the answer data to behavioral trait data, determining a communication style result, and transmitting the result to the user interface.

### BRIEF DESCRIPTION OF SEVERAL VIEWS OF THE DRAWING

FIG. 1 is a flowchart of the central controller of the present invention;

FIG. 2 is a flowchart of the user interface of the present invention;

### DETAILED DESCRIPTION OF THE INVENTION

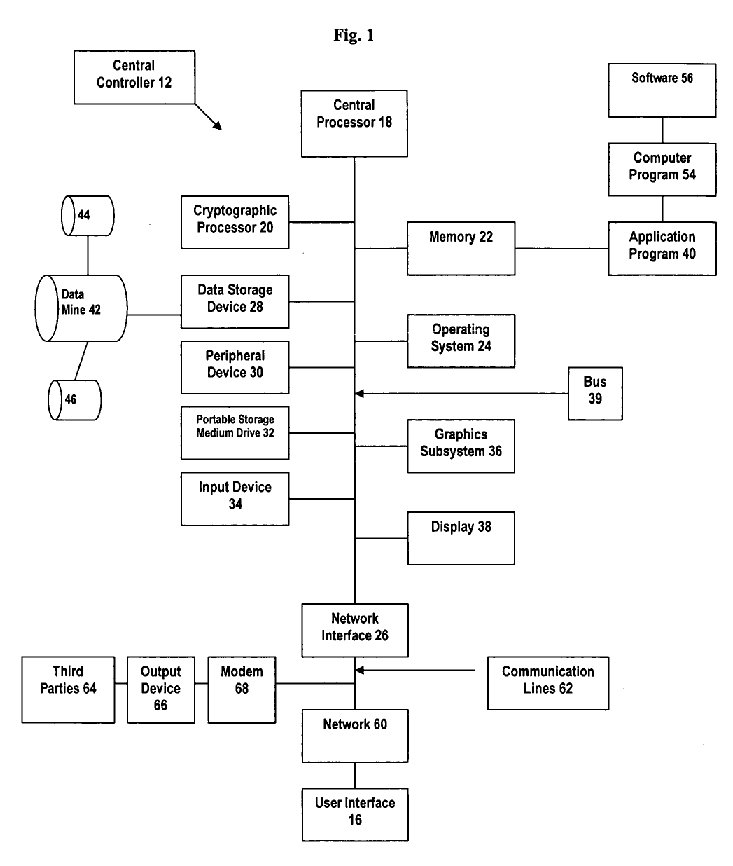

The personnel management system 10 of the present invention includes a central controller, a transmission means, and a user interface. As used herein, a user may be an individual, a corporation, a partnership, a government, or any other entity. FIG. 1 illustrates a high-level block diagram of central controller 12 which may used to implement the method of the present invention. Central controller 12 includes a central processor 18, an optional cryptographic processor 20, memory 22, operating system 24, network interface 26, data storage device 28, peripheral device(s) 30, portable storage medium drive(s) 32, input device(s) 34, graphics subsystem 36, and display 38. The components of central controller 12 are those typically found in general purpose computer systems, and are intended to represent a broad category of such computer components that are well known in the art.

In one embodiment, central controller 12 may be a conventional personal computer or computer workstation with sufficient memory and processing capability to perform the necessary functions of the present invention. In another embodiment, central controller 12 operates as a web server, both receiving and transmitting queries and requests generated by users or organizations. Regardless of its architecture, central controller 12 must be capable of high volume transaction processing and performing a significant number of mathematical calculations in processing communications and repository searches. One skilled in the art will also appreciate that the functionality of central controller 12 may be distributed over a plurality of computers such as a network of computers or a plurality of stand-alone computers. Central controller 12 may be configured in a distributed architecture wherein the repositories and processors are housed in separate units or locations. Some controllers perform the primary processing functions and contain, at a minimum, both memory and a general processor. Each of these controllers is attached to a WAN hub which serves as the primary communication link with the other controllers and interface devices. The WAN hub may have minimal processing capability itself, serving primarily as a communications router. Those skilled in the art will appreciate that an almost unlimited number of controllers may be supported. This arrangement yields a more dynamic and flexible system that is less prone to catastrophic hardware failures affecting the entire system.

Central processor 18 may contain a single microprocessor or it may contain a plurality of microprocessors for configuring central controller 12 as a multi-processor system. Examples of currently available processors that may be suitable as central processor 18 include 64 bit AMD Opteron™ and 64 bit Itanium® from Intel®. Equivalent processors may also be used. However, one skilled in the art will appreciate that newer and faster models will be developed and would be suitable for use in the present invention.

Cryptographic processor 20 is a processor that supports the authentication of communications from and to users, organizations, and central controller 12. Cryptographic processor 20 is also suitable for providing anonymity in transactions, secure processing of electronic transactions, secure electronic data interchange (EDI), Internet commerce servers and all other applications that require high-volume transactions and maximum security. Examples of suitable, currently available apparatus include the IBM® PCI Cryptographic Coprocessor, the Okiok RAC/M IX ICP Cryptographic Processor and the like. Equivalent processors may also be used. However, one skilled in the art will appreciate that newer and faster models will be developed and would be suitable for use in the present invention.

Memory 22 includes random access memory (RAM), dynamic random access memory (DRAM), read-only memory (ROM), as well as high-speed cache memory. Memory 22 may also include an application program 40 that stores, in part, instructions and data for execution by central processor 18. If the system of the present invention is wholly or partially implemented in software, including a computer program, memory 22 stores the executable code when in operation.

Controller 12, as shown in FIG. 1, illustrates operating system 24 as a Windows®-based platform available from Microsoft Corporation that may be used for implementing the method of the present invention. However, numerous other platforms can also suffice for use as operating system 24, such as Macintosh-based platforms available from Apple Computer, Inc., platforms with different bus configurations, various Linux distributions, networked platforms, multi-processor platforms, other personal computers, personal digital assistants (e.g., Palm Pilot®, Blackberry®, Clié®, 3Com, etc.), workstations, mainframes, navigation systems, and the like.

Network interface 26 is the gateway to communication with users through user interface 16 as well as with other users of system 10. Network interface 26 may be a network interface card for interfacing central controller 12 to a network, a modem, or the like. Conventional internal or external modems may also serve as network interface 26. Network interface 26 supports modems at a range of baud rates from 1200 upward, but may combine such inputs into a T1 or T3 line if more bandwidth is required. In a preferred embodiment, network interface 26 is connected with the Internet and/or any of the commercial on-line services such as America Online, MSN, and the like, allowing users access from a wide range of on-line connections. Several commercial electronic mail servers include the above functionality in, for example, mail software packages designed to link people and information over enterprise networks and the Internet. These types of products are platform independent and utilize open standards based upon Internet protocols. Users can exchange messages with enclosures such as files, graphics, video and audio. The system also supports multiple languages. Alternatively, network interface 26 may be configured as a voice mail interface, web site, bulletin board system (BBS), or electronic mail address.

Data storage device 28 is a non-volatile storage device for storing data, software and instructions for use by central processor 18 and is typically implemented with a magnetic disk drive or an optical disk drive. Data storage device 28 also contains data repositories used in the processing of data in the present invention, including a data mine 42 or other data repository containing a behavioral questionnaire repository 44 and a user account repository 46. As one skilled in the art will appreciate, any suitable type of software may be used to create and manage these repositories. Behavioral questionnaire repository 44 maintains data on communication style traits (style data) and data containing questions directed toward determining a user's communication style, e.g., thinker, bridge-builder, energizer or bottom liner (question data). Any traditional behavioral self-perception questions may be used and are within the scope of the present invention. These questions are then tied to traits of the various communication styles. By way of example only, and without limitation, the following table outlines certain traits attributable to the four communication styles that may be included in data 48:

| | Thinker | Bridge Builder | Energizer | Bottom Liner |
|---|---|---|---|---|
| Behavioral Focus | Structure, logic, | Human interaction, | Imagination, | Doing, competing, |
| | problem solving | projection, feelings | envisioning, | getting results |
| | | | speculation | |
| Value Orientation | Quality, being right, | Family, friendship, | Concepts, ideology, | Action, winning, |
| | ethics | loyalty | discovery | wealth |
| Motivated By | Logical, scientific | Love, sense of | Pioneering spirit, | Stimulating action, |
| | challenge, | contribution, | inventing, creating | achievement, |
| | systematic inquiry | recognition | | controlling, gaining |
| | | | | an edge |
| Behavioral comfort | Analytical tasks, | Human interaction | Unstructured | Concrete tasks, |
| zones | logical comparisons, | tasks, probing, | creative tasks, | practical situations, |
| | weighing data, | analyzing others | discovering “why”, | goal-oriented |
| | forecasting results | | using imagination | simplicity |
| Oral | Structured, careful | Personalized, | Professional, stream | Assertive, |
| communication | | marked voice | of consciousness, | controlling, |
| | | inflection | associative | confronting |
| Behavioral | Interpersonal | Structured | Bureaucracy, mass | Free-form, vague, |
| discomfort zones | communication, | situations, taking | psychology, making | hypothetical, moving |
| | situations requiring | orders, impersonal | things happen | slowly, no bottom |
| | fast decisions | relationships | quickly | line |
| Written | Planned, organized, | Unplanned, | Spontaneous, | Short, simple, |
| communication | geometric | spontaneous, warm | abstract, idea- | directed to action |
| | | | oriented | |
| Work environment | Ordered, neat, data | Homey, comfortable | Demanding, fast- | Think-tank, high |
| preference | at hand | | paced, competitive | tech |
| Work content | Problem-solving, | Helping professions, | Research and | Entrepreneurial |
| preference | law, engineering, | acting, selling, | development, sales, | business, financial, |
| | accounting, | cooking, | science new product | investing, |
| | computers, sciences | psychology, | design, planning, | construction, sports, |
| | | ministry, retail | economics, causes, | decision making, |
| | | business | teaching | risk taking |
| Color preference | Cool colors | Warm colors | Color blends | Bright hot colors |
| Dress preference | Conservative | Informal | Unpredictable | Functional |

Questions data may include, by way of example only and without limitation, questions directed toward the following: (1) Assertiveness: whether a person has a desire to control, needs to compete, is aggressive, takes charge, and is assertive; and (2) Responsiveness: whether a person is sociable, warm, open, people-oriented, and makes other people feel comfortable. Other questions may include, but are not limited to: (1) I am likely to impress others as: practical and direct, emotional and somewhat stimulating, objective and logical, or conceptual and creative; (2) In the way I approach my work, I: want it to involve meaningful experiences with others, prefer work that is systematically or logically organized, like to see the tangible benefits that result from my expenditure of time and energy, or prefer novel work or problem-solving that is innovative and advances knowledge; (3) In communicating with others, I tend to: show less interest in thoughts and ideas that show little or no originality, become impatient with people who make leaps of logic or do not express ideas completely, gravitate toward people who express their feelings about an issue or topic, or focus more on the here-and-now, rather than the future; and (4) When circumstances prevent me from doing what I want, I find it most helpful to: objectively review the logic of my approach and modify it accordingly, re-think all that has happened and develop a new hypothesis or model for action, review all the facts, identify the key obstacles, and proceed in a manner that is close to the original plan, or analyze the motivations and concerns of other in order to develop a new awareness of the situation. It will be appreciated by those skilled in the art that style data and question data may include many different types of questions and traits depending upon the individual test being used. It is within the scope of the invention for style data and question data to include any information or questions commonly used in now known or hereafter developed self-perception tests.

Individual or grouped user account data may also be stored in data mine 42 in a user account data repository 46 or some other suitable data storage location. User account data may include, but is not limited to, the user's name, location, business type, username, password, contact information, corporate profiles, employees, clients, and any other information desirable in identifying a particular user. User account data may also be linked to any one of the style or question data that have been previously provided by the particular user so that a user may access archived data already entered into controller 12. As one skilled in the art will appreciate, any suitable type of software may be used to create and manage these repositories.

In another embodiment, data storage device 28 may also store application program 40 for the purpose of loading program 40 to memory 22. Computer software, instructions or data, including style data, question data, or user account data, may also be stored in central processor 18 rather than data storage device 28.

Controller 12 may further include peripheral device(s) 30, portable storage medium drive(s) 32, input device(s) 34, graphics subsystem 36 and display 38. For purposes of simplicity, the components shown in FIG. 1 are depicted as being connected via a single bus 39. However, one skilled in the art will appreciate that the components may be connected through one or more data transport means. For example, processor 18 and memory 22 may be connected via a local microprocessor bus, and data storage device 28, peripheral device(s) 30, portable storage medium drive(s) 32, and graphics subsystem 36 may be connected via one or more input/output (I/O) buses.

Peripheral device(s) 30 may include any piece of hardware or computer support device, such as an input/output (I/O) interface, used to add additional functionality to central controller 12. Other examples of peripheral device(s) 30 include, but are not limited to, printers, scanners, disk and tape drives, microphones, speakers, joysticks, plotters, and cameras.

Portable storage medium drive(s) 32 operates in conjunction with a portable non-volatile storage medium, such as a floppy disk, CD-ROM, or other computer-readable medium, to input and output data and code to and from central controller 12. In one embodiment, program 40, or style, question, and user account data, are stored on a portable medium, and is then inputted to central controller 12 via portable storage medium drive 32.

Input device(s) 34 provides a portion of a user interface with central controller 12. Input device(s) 34 may include an alpha-numeric keypad for inputting alphanumeric and other key information, or a pointing device, such as a mouse, a trackball, stylus, wheel, cursor or direction keys. Such devices provide additional means for interfacing with repositories 44 and 46.

In order to display textual and graphical information, central controller 12 includes graphics subsystem 36 and display 38. Graphics subsystem 36 receives textual and graphical information and processes the information for output to display 38. Display 38 may include a cathode ray tube (CRT) display, liquid crystal display (LCD), projection displays, other suitable display devices, or means for displaying, that enables a user to view data. Display 38 can be used to display data, component interfaces and/or display other information that is part of a user interface.

In a further embodiment, the present invention also includes a computer program 54 that includes a storage medium (media) component having instructions stored thereon which can be used to program a computer to perform the method of the present invention. The storage medium can include, but is not limited to, any type of computer-readable medium including floppy disks, optical disks, DVD, CD-ROMs, magnetic optical disks, RAMs, EPROM, EEPROM, magnetic or optical cards, or any type of media suitable for storing electronic instructions.

Stored on any one of the computer-readable medium (media), the present invention may also include software 56 for controlling both the hardware of central controller 12 or processors 18 and 20, and for enabling central controller 12, processor 18 and cryptographic processor 20 to interact with a human user or other mechanism utilizing the results of the present invention. Software 56 may include, but is not limited to, device drivers, operating systems and user applications. Ultimately, such computer-readable media further includes self-perception test software for performing the method of the present invention. In a preferred embodiment, self-perception test software is downloaded to central controller 12 and stored in memory 22 as part of application program 40. For the purposes of simplicity, all references herein to application program 40 and software 56 include self-perception test software. However, it will be appreciated by those skilled in the art that the self-perception test software may also be stored and executed separately from application 40.

As illustrated in FIG. 1, central controller 12 is connected via network interface 26 to a transmission means such as a network 60 (e.g., an intranet, the Internet, or other network), across communications lines 62. Preferably, communications lines 62 are dedicated lines (e.g., LAN, WAN, standard dial-out telephone line, satellite, dedicated lease line, DSL) with a frame relay (or point-to-point) connection. Central controller 12 may also be directly linked to third party computer systems 64 rather than communicating with central controller 12 through network 60. Third party computer systems 64 may be, for example, a mainframe or PCs (e.g., Pentium CPU) having at least one gigabyte drive, 16 megabytes of RAM, with typical I/O accessories including a keyboard, mouse, and printer or similar workstation. Each third party computer system 64 and central controller 12 and, more specifically, an output device(s) or a server(s) 66, also have a modem 68 (e.g., CSDSU, T1 communication, DSL, satellite or cable modems) for coupling to communication lines 62 and enabling communications between central controller 12 and third party computer system 64.

Data storage device 28, output device or server 66 and memory 22 may be implemented by one digital processor 18. In that case, consolidation, scheduling, initial and subsequent segmenting of end users and execution of working programs are accomplished through the one processor 18. In using the present invention, end users may be assisted by a third party. Alternatively, rule-based expert systems may be similarly employed in the present invention to provide dynamic end user behavioral and characteristics segmentation.

In a preferred embodiment, user interface 16 is a conventional personal computer having, at a minimum, an input device, such as a keyboard, mouse or conventional voice recognition software package, a display device, such as a video monitor, a processing device such as a CPU, and a network interface such as a modem. A cryptographic processor may also be included for stronger authentication protection. These devices interface with central controller 12. Alternatively, user interface 16 may also be a voice mail system, or other electronic or voice communications system such as a PDA, digital telephone, pocket personal computer or the like.

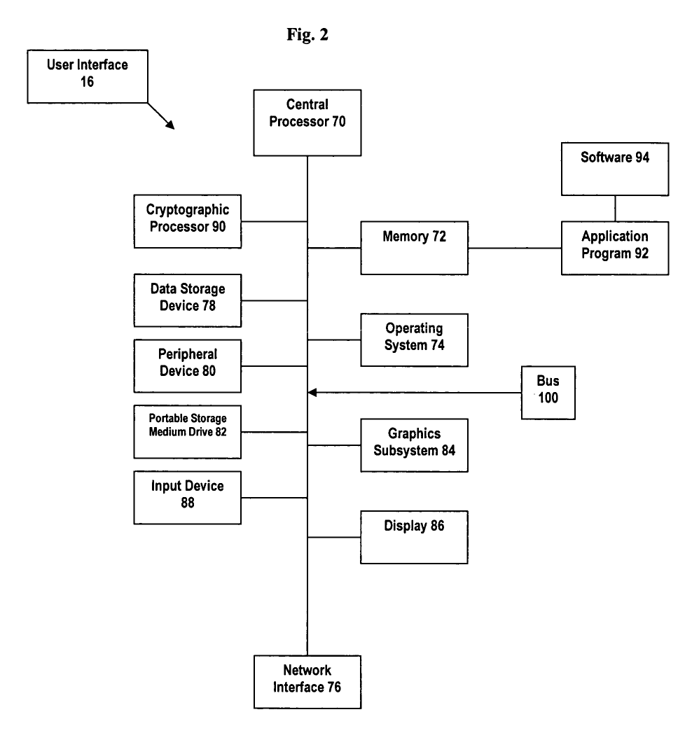

Referring now to FIG. 2, user interface 16 is described in more detail. User interface 16 may include a central processor 70, a memory 72, an operating system 74, a network interface 76, a data storage device(s) 78, a peripheral device(s) 80, a portable storage medium drive(s) 82, a graphics subsystem 84, a display 86, and an input device(s) 88. Cryptographic processor 90 may also be added for stronger authentication and verification capabilities.

Central processor 70 may contain a single microprocessor, such as a Pentium microprocessor, or it may contain a plurality of microprocessors for configuring user interface 16 as a multi-processor system. Cryptographic processor 90 is a processor that supports the authentication of communications to and from user interface 16 and central controller 12. Cryptographic processor 90 is also suitable for providing anonymity in transactions, secure processing of electronic transactions, secure electronic data interchange (EDI), Internet commerce servers and all other applications that require high-volume transactions and maximum security. Examples of suitable, currently available apparatus include the IBM® PCI Cryptographic Coprocessor, the Okiok RAC/M IX ICP Cryptographic Processor and the like. Equivalent processors may also be used. However, one skilled in the art will appreciate that new and faster models will be developed and would be suitable for use in the present invention.

Memory 72 includes random access memory (RAM), dynamic random access memory (DRAM), read-only memory (ROM) as well as high-speed cache memory. Memory 72 may also include an application program 92 that stores, in part, instructions and data for execution by central processor 70. If user interface 16 is wholly or partially implemented in user interface software 94, including a computer program, memory 72 also stores the executable code when in operation. Operating system 74 is shown in FIG. 2 as a Windows®-based platform available from Microsoft Corporation. However, numerous other platforms can also suffice for use as operating system 74, such as Macintosh-based platforms available from Apple Computer, Inc., platforms with different bus configurations, various Linux distributions, networked platforms, multi-processor platforms, other personal computers, personal digital assistants (e.g., Palm Pilot®, Blackberry®, Clié®, 3Com, etc.), workstations, mainframes, navigation systems, and the like.

Network interface 76 is the gateway to communication with central controller 12. Network interface 76 may be a network interface card for interfacing user interface 16 to a network, a modem, or the like. Conventional internal or external modems may also serve as network interface 76. In a preferred embodiment, network interface 76 is connected with the Internet and/or any of the commercial on-line services such as America Online, MSN, and the like, allowing users access to central controller 12 from a wide range of on-line connections. Several commercial electronic mail servers include the above functionality in, for example, mail software packages designed to link people and information over enterprise networks and the Internet. These types of products are platform independent and utilize open standards based upon Internet protocols. Users can exchange messages with enclosures such as files, graphics, video and audio. The system also supports multiple languages. Alternatively, network interface 98 may be configured as a voice mail interface, web site, BBS, or electronic mail address.

Data storage device 78 is a non-volatile storage device for storing data, software and instructions for use by central processor 70 and is typically implemented with a magnetic disk drive or an optical disk drive. Data storage device 78 may be used for archiving data 48, 50 and 52. In another embodiment, data storage device 78 may also store application program 92 for the purpose of loading program 92 to memory 72. Computer software, instructions or data, including style, question, or user account data may also be stored in central processor 70 rather than data storage device 78.

User interface 16 may further include peripheral device(s) 80, portable storage medium drive(s) 82, graphics subsystem 84, display 86, and input device(s) 88. For purposes of simplicity, the components shown in FIG. 2 are depicted as being connected via a single bus 100. However, one skilled in the art will appreciate that the components may be connected through one or more data transport means. For example, processor 70 and memory 72 may be connected via a local microprocessor bus, and data storage device 78, peripheral device(s) 80, portable storage medium drive(s) 82, and graphics subsystem 84 may be connected via one or more input/output (I/O) buses.

Peripheral device(s) 80 may include any piece of hardware or computer support device, such as an input/output (I/O) interface, used to add additional functionality to user interface 16. Other examples of peripheral device 80 include, but are not limited to, printers, scanners, disk and tape drives, microphones, speakers, joysticks, plotters, and cameras.

Portable storage medium drive 82 operates in conjunction with a portable non-volatile storage medium, such as a floppy disk, CD-ROM, or other computer-readable medium, to input and output data and code to and from user interface 16. Program 92 or style, question, or user account data may be stored on a portable medium, and then inputted to user interface 16 via portable storage medium drive 82.

In order to display textual and graphical information, user interface 16 includes graphics subsystem 84 and display 86. Graphics subsystem 84 receives textual and graphical information and processes the information for output to display 86. Display 86 may include a cathode ray tube (CRT) display, liquid crystal display (LCD), projection displays, other suitable display devices, or means for displaying, that enables a user to view data. Display 86 can be used to display data, component interfaces and/or display other information that is part of a user interface.

Input device(s) 88 provides a portion of a user interface with user interface 16. Input device(s) 88 may include an alpha-numeric keypad for inputting alphanumeric and other key information, or a pointing device, such as a mouse, a trackball, stylus, wheel, cursor or direction keys. Such devices provide additional means for interfacing with user interface 16 and, ultimately, central controller 12.

In a further embodiment, the present invention also includes a computer program that includes a storage medium (media) component having instructions stored thereon which can be used to program a computer to perform the method of the present invention. The storage medium can include, but is not limited to, any type of computer-readable medium including floppy disks, optical disks, DVD, CD-ROMs, magnetic optical disks, RAMs, EPROM, EEPROM, magnetic or optical cards, or any type of media suitable for storing electronic instructions.

Stored on any one of the computer-readable medium (media), the present invention may also include user interface software 94 for controlling both the hardware of user interface 16 or processor 70, and for enabling user interface 16 and processor 70 to interact with a human user or other mechanism utilizing the results of the present invention. Software 94 may include, but is not limited to, device drivers, operating systems and user applications.

Many commercial software applications are available to enable the communications required by user interface 16. When central controller 12 acts as a web server, conventional communications software such as the Internet Explorer web browser from Microsoft Corporation or the Netscape Navigator® web browser from Netscape Corporation may also be used. No proprietary software is required.

The present invention also provides a method for developing and managing interpersonal relationships in the workplace. In the preferred embodiment, the steps of the present invention are embodied in machine-executable instructions as previously described herein. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components. In one embodiment of the present invention, when central controller 12 acts as a web server, a user logs on to the central controller 12, makes queries or requests, inputs information or generates data, and then disconnects from the network. Central controller 12 is connected to a corresponding web site on the Internet thereby allowing the user to provide and request information through the interface of conventional web browser software such as Internet Explorer from Microsoft Corporation. The web site has a home page with topic selections and links (e.g., hypertext HTML technology) to application program 40 thereby triggering searches and initiating transfer of data 46 and 48 and other desired information. In particular, for each topic or field selection there is a respective hyperlink to application program 40 and optionally an event for initiating program 40. Upon the user's selection of a topic from the web page, the present invention applies the linked event, if any. If the criteria of the event are met (or if there is no initiating event), then the present invention executes the corresponding application program 40.

With respect to implementation of a process according to the present invention, by which a user accesses style, question, or user account data, it will be appreciated by those skilled in the art that buttons or drop-down menus may be provided on a web page for ease of selection and linking to appropriate web pages during performance of the method of the present invention. The user logs on to central controller 12 using network interface 76 of user interface 16 thereby establishing a communication link. A unique username and password may be provided to the user which allows information particular to the user to be made available for viewing by the user. The user inputs an assigned username and password into appropriate fields on the web page and the user's identity is verified by transmitting the information to central controller 12 which then matches the username and password against a particular account in user account repository 46. If a correct username and password has been provided by the user, central controller 12 transmits that portion of the user account data that corresponds to the user's account information to user interface 16. If, for example, the user is a company manager, the user's account information may include a complete list of all employees and information regarding whether the employees have answered the behavioral questionnaire to determine their communication styles and the results of the questionnaire so that the manager may track and monitor compliance with company guidelines regarding the behavioral questionnaire.

A user may choose to take a behavioral questionnaire by clicking on the appropriate link or using a drop-drop menu or other suitable HTML technology that is linked to application program 40. Application program 40 then copies and transfers pre-determined question data from repository 44 and transmits the questions generated to user interface 16 for viewing by the user. The user may then input answers to the questions using the interface provided. The user's answers are transmitted to central controller and linked to behavioral traits in the style data. Depending upon the traits identified in the style data, the communication style of the user is processed and transmitted to the user as a results page in a report or other easily-viewable format. While it is preferred that the user answer the questionnaire only once, it is within the scope of the present invention to allow the user to re-start the questionnaire and for application program 40 to generate a different answer set relating to communication styles from the style data. Via the appropriate link or drop-down menu and utilizing electronic mail servers, users may also request that a hard or electronic copy of the questionnaire be sent via electronic mail or via the U.S. Postal Service.

In an off-line embodiment of the present invention, users communicate in an off-line manner with central controller 12. Rather than sending electronic mail or using web-based servers, users use a telephone, fax machine, postal mail, or other off-line communication tool. For example, the user may call central controller 12 and be connected with an agent. The user may request user account data or take the questionnaire utilizing the style and question data. The user also provides a unique ID, username, password or private key so that central controller 12 can authenticate the user's identity. The agent puts this data into digital form by typing it into a terminal or other input device 34 and retrieves style, question, or user account data to convey to the user.

In an alternative embodiment, the user calls central controller 12 and is connected with a conventional interactive voice response unit which allows the user to enter an account number or other data without the aid of a live agent. The user initially selects from a menu of subjects using the touch-tone keys of a telephone, and then the call is either directed to a live agent specializing in that subject area, or the user is prompted for further information.

Regardless of the method used to generate a communication style result, once a user's communications style is determined, that information is conveyed to an employer, an agent, or some other central figure to be compared against other users in the user account. The comparison may be made electronically, such as, for example, by using a program to compare results in a given database, or may be done manually by an individual with access to the information. Those persons with similar communication styles are then assigned work tasks with each other and work tasks with persons having contrasting communication styles are avoided. For example, executives at Company A attend a live seminar discussing the four communication styles and how a business can run more smoothly when like personalities work together. The executives and other company employees then take the behavioral questionnaire electronically or off-line as described herein. The company then reviews the results of the questionnaires and assign Employee A who has a bridge-builder communication styles to projects with other bridge-builder communicators. Similarly, Employee B who has a thinker communication style is assigned to work with other thinkers. Those with conflicting styles, such as thinkers and energizers, are generally not assigned to work with one another, although depending on the goals of the business or organization, it may be desirable to assign those with conflicting styles to work with one another. Using this method, a business increases its productivity, eliminates frustration among its workforce, and reduces duplication of effort. It will be appreciated that this process of matching communication styles could be applied to clients and across industries. For example, if a particular client has an energizer communication style, it is inefficient to pair that client with an account manager having a thinker style. Rather, utilizing the results of the behavioral questionnaire, the company would re-assign the thinker account manager to a thinker client and an energizer account manager to an energizer client. Similarly, when referring business, the method of the present invention may also be used. For example, a bottom-liner attorney having a bottom-liner client in need of accounting services would recommend a CPA also having a bottom-liner communication style. In this way, communication among all parties is improved and more productive. It will be appreciate, however, that the present invention is not limited to commercial or business uses, and will have applicability in a wide range of interpersonal settings.

The foregoing description of the embodiments of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and modifications as are suited to the particular use contemplated. It is intended that the scope of the invention not be limited by the specification, but be defined by the claims set forth below.

We claim:

1. A method for developing and managing personnel comprising the steps of:
(a) providing a user interface;
(b) logging on to a central controller from said user interface;
(c) establishing a communication link with said central controller;
(d) inputting answer data in response to queries transmitted by said central controller;
(e) linking said answer data to behavioral trait data;
(f) determining a communication style result; and
(g) transmitting said result to said user interface.

2. The method of claim 1, said logging on step further comprising inputting a unique identifier corresponding to a particular user.

3. The method of claim 2 wherein said unique identifier is selected from the group consisting of a username, password, and combinations thereof.

4. The method of claim 2 further comprising the step of providing a user account corresponding to said unique identifier wherein said user account comprises user account data.

5. The method of claim 1 further comprising the step of transferring query data from a query data repository to said user interface.

6. The method of claim 1, said communication style result being selected from the group consisting of thinker, bridge builder, energizer, bottom liner, and combinations thereof.

7. The method of claim 1, said communication style result being selected from the group consisting of subtle, direct, personable, task-oriented, and combinations thereof.

8. The method of claim 1 further comprising the step of providing a report in a pre-defined format containing said answer data and said communication style result.

9. The method of claim 1 further comprising the step of adding said answer data and said communication style result to a list of preferred data maintained in said user account.

10. The method of claim 1 wherein said user interface is selected from the group consisting of a computer, personal digital assistant, pager, telephone, fax machine, and combinations thereof.

11. The method of claim 1 wherein said central controller comprises a computer, an interactive voice response unit, an operator, and combinations thereof.

12. The method of claim 1 wherein said user is assigned a work task suitable for said communication style result.

13. The method of claim 12 wherein said user is assigned a work task with other users having the same communication style result.

14. A method for managing interpersonal relationships comprising:
(a) providing at least one question to a first user;
(b) retrieving answer data from said first user in the form of said first user's answers to said at least one question;
(c) linking said answer data to at least one behavioral trait; and
(d) determining a communication style of said first user based on the linking of said answer data to said at least one behavioral trait.

15. The method of claim 14 further comprising the step of:
(e) performing steps (a) through (d), above, with respect to at least one additional user,
wherein users chosen from said first user and said at least one additional user are assigned to work with one another based on said users having the same communications style.

16. The method of claim 14 wherein said user is assigned a work task based on said communications style.

17. The method of claim 14 wherein said communication style being determined is chosen from the group consisting of thinker, bridge builder, energizer, bottom liner, and combinations thereof.

18. The method of claim 14 wherein said communication style being determined is chosen from the group consisting of subtle, direct, personable, task-oriented, and combinations thereof.
